(19) United States
(12) Patent Application Publication
(10) Pub. No.: US 2013/0346494 A1
(43) Pub. Date: Dec. 26, 2013

(54) CLOUD-BASED SYSTEM AND METHOD FOR SHARING MEDIA AMONG CLOSELY LOCATED DEVICES

(71) Applicants: Juana E. Nakfour, Hawthorn Woods, IL (US); Sambhavi Jayavelan, Round Lake Beach, IL (US)

(72) Inventors: Juana E. Nakfour, Hawthorn Woods, IL (US); Sambhavi Jayavelan, Round Lake Beach, IL (US)

(73) Assignee: MOTOROLA MOBILITY, INC., Libertyville, IL (US)

(21) Appl. No.: 13/530,158

(22) Filed: Jun. 22, 2012

(51) Int. Cl. G06F 15/16; H04W 8/00

(52) U.S. Cl. 709/204

(57) ABSTRACT

A method for sharing data between a local device and a target device includes scanning for a fallback peer-to-peer (P2P) network by the local device. When the scanning finds the fallback P2P network, the local device joins the P2P network in order to connect to a target device. The local device can also create a fallback P2P network when the scanning does not find said fallback P2P network. The local device searches for a target device, using a Bluetooth generic attribute (GATT) personal device profile (PDP) protocol; and is capable of sharing a data file between the local and target devices upon receiving an indication that the target device had connected to said fallback P2P network. In response to a triggering event, the local and target devices connect to the P2P network to thereby support file sharing.

### TECHNICAL FIELD

The present disclosure relates generally to methods and apparatus for sharing media among cloud-based linked devices, and more particularly to the use of a personal peer-to-peer network for connecting devices in close proximity to one another and continuing cloud-based media sharing without requiring simultaneous Internet connectivity.

### BACKGROUND

Consumers increasingly desire to share (e.g., stream) media across a variety of devices, such as desktop computers, laptop computers, netbooks, mobile Internet devices (MIDs), smartphone mobile handsets, “nettop” computers, gaming consoles, ebooks, digital cameras, MP3 and other audiovisual display and playback devices, multi-media player, cable set-top boxes, personal digital assistants (PDAs), televisions, and numerous other computing and telecommunication devices configured to communicate using any suitable data communication protocols such as TCP/IP, Wi-Fi, WiMax, CDMA, Bluetooth, 3G, 4G, and the like.

Known file sharing systems employ a cloud-based meta-file system which requires both the local and remote devices to have an active Internet connection during the streaming or file sharing process. Requiring both devices to simultaneously maintain an active Internet connection, in turn, requires both devices to be “awake” (or enabled). This limits the ability to access media from devices which are not currently connected to the Internet, or which may be “off” or “asleep”. Requiring simultaneous active Internet connections also consumes unnecessary bandwidth, power, and connectivity resources, particularly when a local peer-to-peer connection can more quickly and/or efficiently support file sharing.

Furthermore, other desirable features and characteristics will become apparent from the subsequent detailed description and the appended claims, taken in conjunction with the accompanying drawings and this background.

### BRIEF DESCRIPTION OF THE DRAWING FIGURES

The present disclosure will hereinafter be described in conjunction with the following drawing figures, wherein like numerals denote like elements, and wherein:

FIG. 1 is a schematic diagram of a file sharing system in accordance with an embodiment;

FIG. 2 is a block diagram of a network device in accordance with an embodiment;

FIG. 3 is a flow diagram illustrating a method for initial user registration of a device in accordance with an embodiment;

FIG. 4 is a flow diagram illustrating a method of implementing a fallback peer-to-peer (P2P) network in accordance with an embodiment;

FIG. 5 is a block diagram illustrating various possible triggers for initiating a fallback P2P network in accordance with an embodiment;

FIG. 6 is a flow diagram illustrating a method of associating devices with a P2P network in accordance with an embodiment;

FIG. 7 is a flow diagram illustrating a method of discovering closely located devices belonging to the same P2P network in accordance with an embodiment;

FIG. 8 is a flow diagram illustrating the use of a host status service to wake up local proximity devices and exchange network credentials with the devices;

FIG. 9 is a flow diagram illustrating an alternate method of implementing a fallback P2P network in accordance with an embodiment; and

FIG. 10 is a flow diagram illustrating a further alternate method of implementing a fallback P2P network in accordance with an embodiment.

### DETAILED DESCRIPTION

The following detailed description is not intended to limit the application and uses of the system and methods described herein. Furthermore, there is no intention to be bound by any theory presented in the preceding background or the following detailed description.

Embodiments disclosed herein provide systems and methods for facilitating file sharing between or among devices using peer-to-peer connectivity, as opposed to using the Internet to support connectivity. As used herein, the term “Internet” refers to that global system of interconnected computer networks that predominantly use the standard Internet protocol suite (often called TCP/IP) and which support the World Wide Web (WWW). The term “cloud”, as used herein, refers to a central server (or group of servers) residing on the Internet through which devices may communicate, or become linked or connected. In addition, registration and authentication information and data such as tokens, passwords, and proprietary (private) network protocols may also be stored in and accessed through the cloud.

A peer-to-peer (P2P) network, on the other hand, refers to a personal or private computer network in which each device in the network can act as a client or server for the other devices, allowing shared access to files without the need for a central server. In the context of the present disclosure, a P2P network typically involves a plurality of electronic devices owned by or associated with a particular person, small business, or the like. For example, an individual named “Susan” may wish to define and configure a P2P network having the name “Susan” to include her smart phone, laptop computer, MP3 player, and desk top computer. Each computer or device (also called a node) in the P2P network must use the same (or a compatible) programs and protocols to connect to each other, and to access files located on the other devices. The P2P network may be, but need not be, implemented through the Internet.

Methods and apparatus are provided which permit a user to access Media—using a local (e.g. hand-held or portable) device—which is located on a remote device, without requiring both devices to maintain an active Internet connection during file sharing or streaming.

In one embodiment, a method of sharing data files among electronic devices includes scanning for a fallback peer-to-peer (P2P) network by a first device, joining the fallback P2P network when scanning finds the fallback P2P network and creating the fallback P2P network when scanning does not find it, searching for a second device, with a first device, using a Bluetooth generic attribute (GATT) personal device profile (PDP) protocol, connecting the second device to the fallback P2P network, and sharing a data file between the first and second devices. The Bluetooth generic attribute (GATT) PDP protocol may include at least one of the following protocols: Bluetooth Low Energy (BLE); Bluetooth basic rate (BR); and Bluetooth enhanced data rate (EDR). The first and second devices may be associated with a single user account, multiple user accounts, or different users, and may be cloud-based devices.

The method further includes the first device, for example, verifying whether the second device is connected to the fallback P2P network, for example, by verifying user logged on information in the cloud using a User Identity Service as a GATT service over at least one of Bluetooth Low Energy (BLE), Bluetooth basic rate (BR), and Bluetooth enhanced data rate (EDR). In an embodiment, searching for a second device includes determining whether the second device is on a BLE whitelist.

The method further includes adding the second device to the whitelist if it is not already on the whitelist. The method involves synchronizing the BLE whitelist stored on the first device with a web-based whitelist stored on a central server cloud computer.

In one embodiment, verifying involves determining whether the second device is in a sleep mode and, if the second device is not asleep, connecting the first and second devices via the fallback P2P network. When the second device is asleep, the method includes waking up the second device prior to connecting the first and second devices via the fallback P2P network. In an embodiment, verifying includes determining whether the second device is asleep using a Host Status Service.

The method further includes communicating, by the first device to the said second device, network credentials associated with the fallback P2P network. In an embodiment, communicating includes communicating network credentials using a Wi-Fi Network Service. The P2P network credentials include at least one of: a network name; a network SSID; a network type; a network password; and a network security protocol. In an embodiment, the fallback P2P network may be compliant with Bluetooth, BLE, Wi-Fi, and/or IEEE 802.11 protocols.

The method may involve sharing a media file, including streaming media from the first device to the second device, or alternatively streaming media from the second device to the first device, or streaming media, in general, between first and second devices. The media file may be of a text, graphics, and/or video format, or combination thereof, for example.

In an embodiment, scanning may be in response to a trigger condition including at least one of: network handoff rate exceeding a predetermined threshold value; out of band proximity detection; movement of one of said first and second devices into a predetermined geographic region; termination of an Internet connection of at least one of said first and second devices; and the distance between said first and said second devices becomes less than a predetermined value.

The method further includes, prior to connecting the second device to the fallback P2P network, accessing media located on the second device from the first device via a web-based central server and, after connecting the second device to the fallback P2P network, continuing to access media located on the second device via the fallback P2P network.

A method of sharing media files among associated electronic devices using a fallback peer-to-peer (P2P) network is also provided. The method includes: scanning for a fallback P2P network by a first device; when the fallback P2P network is found, joining the P2P network and searching for a second device; when the second device is found, connecting the first device to the second device via the fallback P2P network; when the second device is not found, searching for a second device, with the first device, using a Bluetooth generic attribute (GATT) personal profile protocol; and connecting the first and second devices via the fallback P2P network.

An apparatus for streaming media stored on a closely proximate device includes a memory module configured to store a device-based whitelist of associated devices including the closely proximate device, an Internet connection module configured to connect to a web-based central server and to synchronize the device-based whitelist with a cloud-based whitelist maintained on said central server. The apparatus also includes a searching module configured to search for the closely proximate device using a Bluetooth generic attribute (GATT) personal profile protocol, and a P2P network connection module configured to connect to the closely proximate device through a fallback P2P network when the closely proximate device is found by the searching module.

In a further embodiment, a method for managing electronic devices belonging to the same user account involves storing a first whitelist on a first device, storing a second whitelist on a web-based central server; searching, by the first device, for target devices in close proximity to the first device; connecting the first device to the central server; and synchronizing the first and second whitelists. In an embodiment, searching includes searching using a User Identity Service.

The method further involves connecting the first device to a P2P network prior to searching. The method also includes storing a third whitelist on a third device, and synchronizing the first, second, and third whitelists when searching discovers the third device. In one embodiment, the first and second whitelists include: i) information relating to the identity of devices stored on the whitelists; and ii) information relating to P2P network connectivity for devices stored on the whitelists.

The Personal Device Profile (PDP) is a GATT (Generic Attribute Profile) based profile. Its goal is to discover personal device information of closely proximate devices. It also allows devices to change the status of other devices by invoking a characteristic write command. This profile can include the following three GATT services: User Identity Service; Host Status Service; and Wi-Fi Network Service.

The function of the User Identity Service is to exchange information pertaining to the users on the devices. This information, for example, can include, but is not limited to: i) User cloud logged in name; ii) User icon; iii) Device ID; and iv) User Activity.

The Host Status Service may have two functions. One can be reading host status information from a target device such as “awake”, “asleep”, etc. The second function can be to provide a write characteristic method that triggers changing the state of the target host. For example, writing a 1 as a characteristic will trigger a wake up condition. Writing a 2 as a characteristic will trigger a sleep condition.

The function of the Wi-Fi Network Service is to exchange Wireless Interface Network status and current network configuration. The information can include, but is not limited to: i) Wi-Fi Network status; ii) Wi-Fi Network Name; and iii) Wi-Fi Network Credentials.

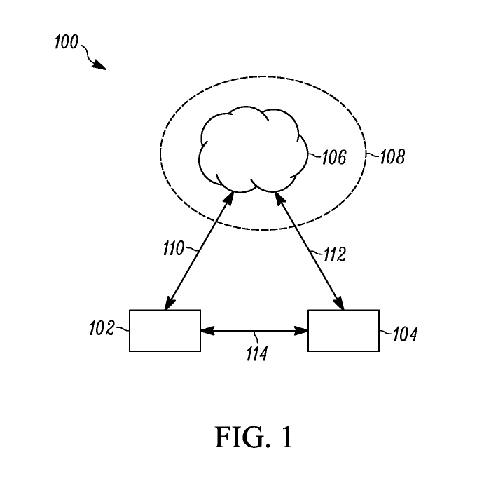

FIG. 1 is a schematic diagram representation of a file sharing system 100 in accordance with an embodiment. Although various embodiments are discussed below with reference to hand-held, laptop, and portable electronic devices, the systems and methods discussed herein are equally applicable to any type of device having P2P network connectivity capability. In the illustrated embodiment, the file sharing system 100 includes a first electronic device 102, a second device 104, and a central cloud 106 accessible by both devices via the Internet 108. In the illustrated embodiment, device 102 is sometimes referred to as the local device, i.e., the device operated by the user to retrieve data or stream media from a remote device on which the media is stored or located. Thus, device 104 may be referred to as the remote device from which the remote media is retrieved.

Device 102 may access the Internet through any suitable link 110; device 104 may access the Internet through a link 112. Links 110, 112 may comprise any suitable wired or wireless link such as a direct Internet connection through a cable modem (not shown), or an indirect connection such as Wi-Fi or any suitable link such as those compliant with IEEE 802.11 or other applicable standard.

Respective devices 102, 104 may be, for example, a handheld wireless device, such as a mobile phone, a Personal Digital Assistant (PDA), a smartphone, tablet computer, or laptop computer, including an Ultrabook, for example; a multimedia player, a gaming device, a MP3 player, a digital broadcast receiver, remote controller, or any other electronic apparatus which is configured for connection to the Internet and/or to another device through a P2P network 114, as described in greater detail below. Many embodiments may be portable or hand-held, but this is not required.

In one embodiment, one or both devices is a cellular telephone (e.g., a smartphone) that streams media from a closely located device through a network link such as, for example, a wireless telecommunication network, the Internet, a public switched-phone network, and the like, and the type of information exchanged with the network may include voice communication, digital data, SMS messaging, MMS messaging, Internet access, multi-media content access, voice over internet protocol (VoIP), and other conventional communication standards and protocols.

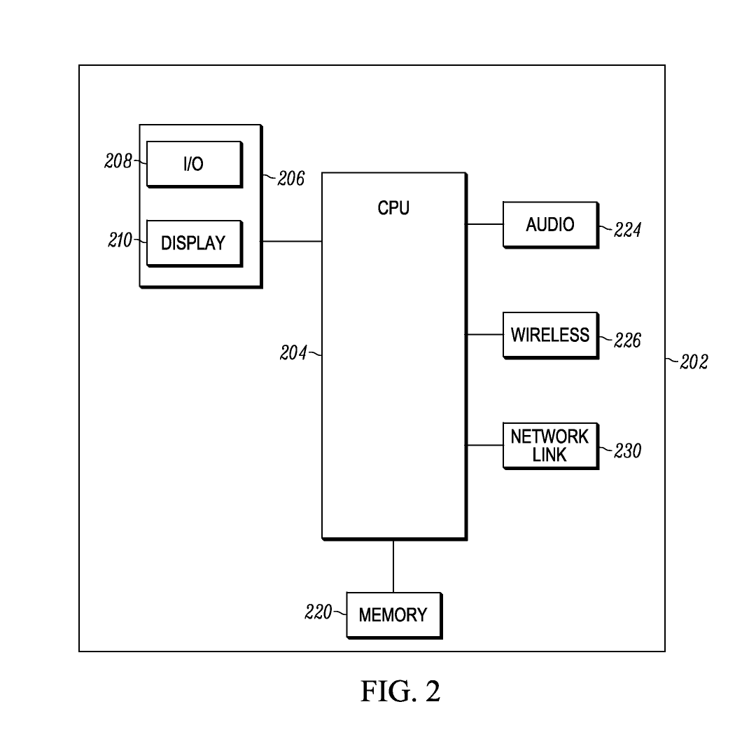

FIG. 2 is a block diagram illustrating the salient features of device 202 (such as local device 102 and/or remote device 104) of FIG. 1 accordance with an embodiment. In one implementation, device 202 includes a controller 204 (e.g., a central processing unit (CPU)), a memory module 220, and a user interface 206 including a user input module 208 (such as a keyboard or keypad) and a display 210 (e.g., a screen or monitor for displaying text, graphics, and/or video).

Device 202 further includes one or more input/output (1/0) modules such as, for example, an audio module 224 (e.g., one or more speakers), a wireless communications module 226 such as a cellular transceiver or wireless network interface (e.g., Bluetooth, Wi-Fi), and a network link 130 such as a USB, Ethernet, fire wire, or other suitable network connection or data port. One or both of wireless communications module 226 and network link 230 may be configured for connection to the Internet and/or for connection to another device through a suitable P2P network, as described in greater detail below.

In general, the controller 204 controls the operation of the device 202 in accordance with computer instructions stored in memory 220. The controller 204 may be implemented using a digital signal processor, microprocessor, microcontroller, programmable logic unit, discrete circuits, or a combination thereof.

The memory 220, coupled to the controller 204, stores software, firmware, and/or other instructions or programs for performing the functions described herein, including operation of the device 202 and for establishing connections to the Internet and/or connections to another device through a P2P network. The memory 220 may also include an operating system, various application programs, and data files such as media files. The memory 220 can include one or more forms of volatile and/or non-volatile, fixed and/or removable memory, such as read-only memory (ROM), electronic programmable read-only memory (EPROM), random access memory (RAM), and erasable electronic programmable read-only memory (EEPROM), optical memory or any other type of memory. The memory 220 may be arranged and configured to store information to be used by other components of the device 202, including the user interface 206, the audio module 224, wireless communications module 226, and network link 230.

The device 202 may also include a variety of other components (not shown) based on the particular implementation. For example, if the device is implemented as a mobile phone, it would also include a microphone and a wireless transceiver and possibly additional input components such as a keypad, accelerometer, and vibration alert. If the device is implemented as a remote controller, an infrared transmitter could also be included.

As noted above, the device 202 may be a communications device that supports various communication functions, including telephony, email, and web-browsing. As such, the controller 204 may control the device to transmit, receive, modulate, or demodulate communications to and from a network, including wide area networks (WAN), such as cellular networks, local area networks (LAN), personal area networks (PAN), or any other type of network. These functions may be facilitated by the audio module 224, the wireless communications module 226, and the network link 230. The wireless module 226 may include a transceiver, transmitter or receiver such that the device may communicate with a wireless or cellular network. The audio module 224 may include a microphone, a port, a speaker, a transducer, or any audio input and output circuitry for converting audible signals to and from digital signals.

In an embodiment, a local device can share files with or retrieve files from a remote device over the Internet. In certain circumstances, however, it may be desirable for the local device to communicate with (e.g., access files from or stream data from) a remote device through a P2P connection, either in addition to or in lieu of the Internet. For example, it may be advantageous to use a P2P fallback connection when the Internet is not available to one or both of the local and remote device(s), when the Internet connection is unstable, slow, or otherwise unsatisfactory, or to conserve power, connection, bandwidth, or other network resources. In such cases the local device may establish a connection with the remote device through a proprietary or personal P2P link, as described below.

Referring again to FIGS. 1 and 2, device 202 (that is, devices 102 and 104) preferably includes suitable hardware and software (e.g., local client and local server) for establishing Internet connections and for implementing the well-known client/server functions typically implemented by devices on a P2P network. These functions include the ability to register a user account, authenticate a user and one or more devices associated with the user account, provide session tokens to allow authenticated devices to communicate with each other either through the central server cloud via the Internet, or using a proprietary P2P network wherein the P2P network credentials are stored in the cloud and downloaded to the devices associated with the P2P network.

The method of reverting to a fallback P2P network in response to a trigger (or triggering condition or event) involves configuring a user defined P2P network and storing its associated network credentials in the cloud 106. When a user logs into the cloud with a new device, the system downloads the P2P network credentials from the cloud, stores them in the device, and uses the credentials to connect to other target devices, for example, when no Internet is available. In this regard, note that in order to participate in the P2P network, a device must have Internet access at some point in order to download the P2P credentials and network configuration information. Once the network credentials and configuration information are stored locally on a device, it can thereafter initiate (enable) a P2P network connection and share files with other devices on the P2P network without further need for an Internet connection. That is, initial registration and authentication can be done through the cloud 106, which accesses the Internet, to the extent the cloud is located on the Internet.

In accordance with an embodiment, the devices on the P2P network generally must be in relatively close geographic proximity, inasmuch as typical P2P network protocols and standards have a limited geographic range.

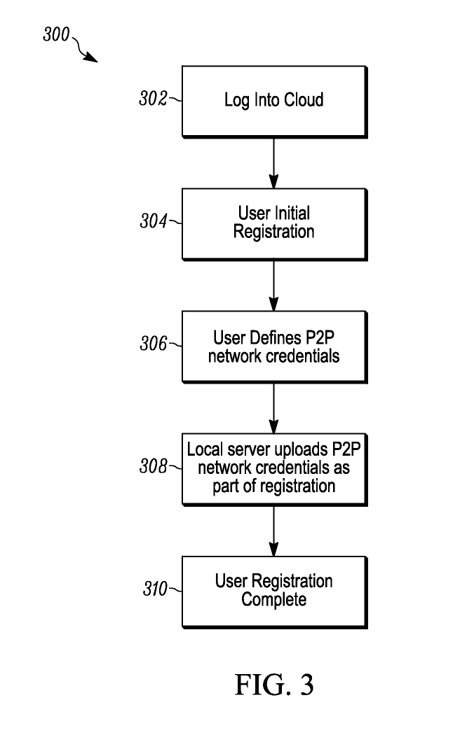

Referring now to FIG. 3, a method 300 for initial user registration includes logging (task 302) on to the central server cloud 106 using a local device 102, and creating and configuring (task 304) a user account, which may also include associating the device 102 (or any other device) with the user account. This registration and authentication information associated with the user account is stored in the cloud 106 for later access by the user using the same or a different device.

Method 300 continues by defining and configuring (task 306) the P2P network and associated credentials. More particularly, if the P2P network type is Wi-Fi Direct (a standard that allows Wi-Fi devices to connect to each other without a wireless access point) or Wi-Fi IBSS (independent basic service set), the user can specify a private network name (a 32-character alphanumeric key known as the service set identifier or “SSID”), Wi-Fi security method, indicate a desired network channel, and define a security passphrase. Typical Wi-Fi security methods include the Wi-Fi protected access protocol (WPA) and the Wi-Fi protected access protected access protocol 2 (WPA2), the wired equivalent privacy protocol (WEP), and the IEEE 802.1X protocol (typically used for Ethernet applications and workplace environments).

Thus, P2P network credentials may be defined as follows:
Network Type: Wi-Fi Direct
Network Name: Jacky2244
Network Security: WPA2
Network Channel: 3
Security Passphrase: “JackyRules”

Upon authentication, method 300 continues by uploading and storing (task 308) the P2P network credentials at the central server 106, and associating the credentials with that specific user account. When the user subsequently logs on to the cloud with the same or another device, the local client embedded within the device can download the credentials from the cloud. The user then completes (task 310) initial registration, for example, by logging off.

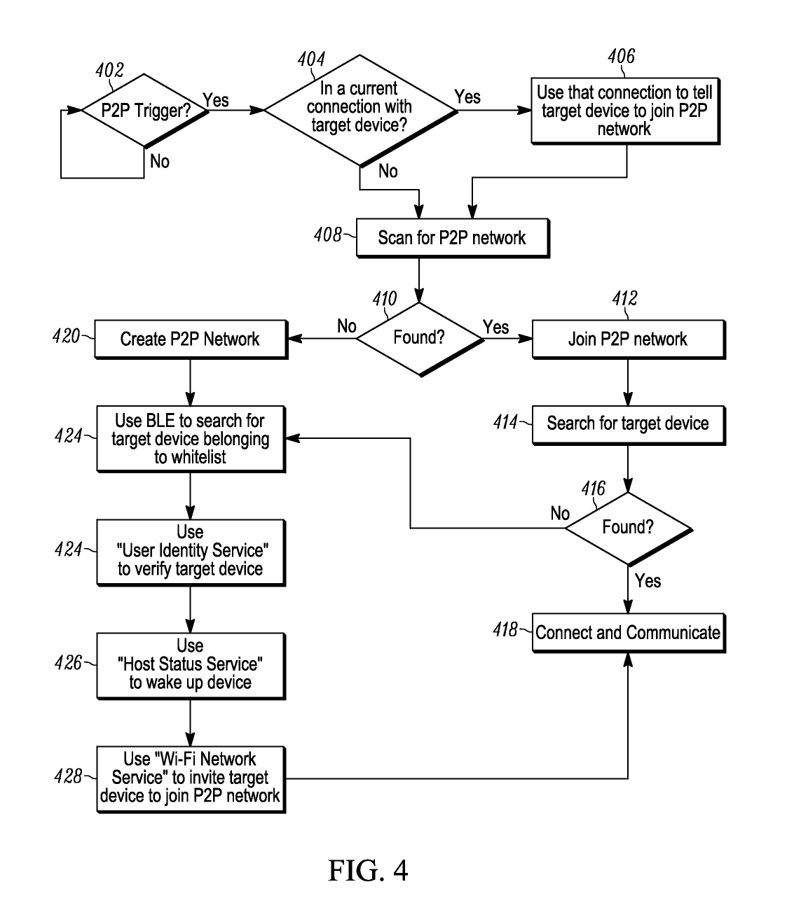

Referring now to FIG. 4, a flow diagram 400 illustrates a policy for a connecting to a fallback P2P network in accordance with an embodiment of the present disclosure. In particular, a device performs ongoing checks (task 402) to see if it needs to fallback to a P2P connection; that is, it determines if a triggering event has occurred which requires the use of a P2P connection. If a trigger has not occurred (“No” branch from task 402), the device continues to poll for a trigger (Task 402).

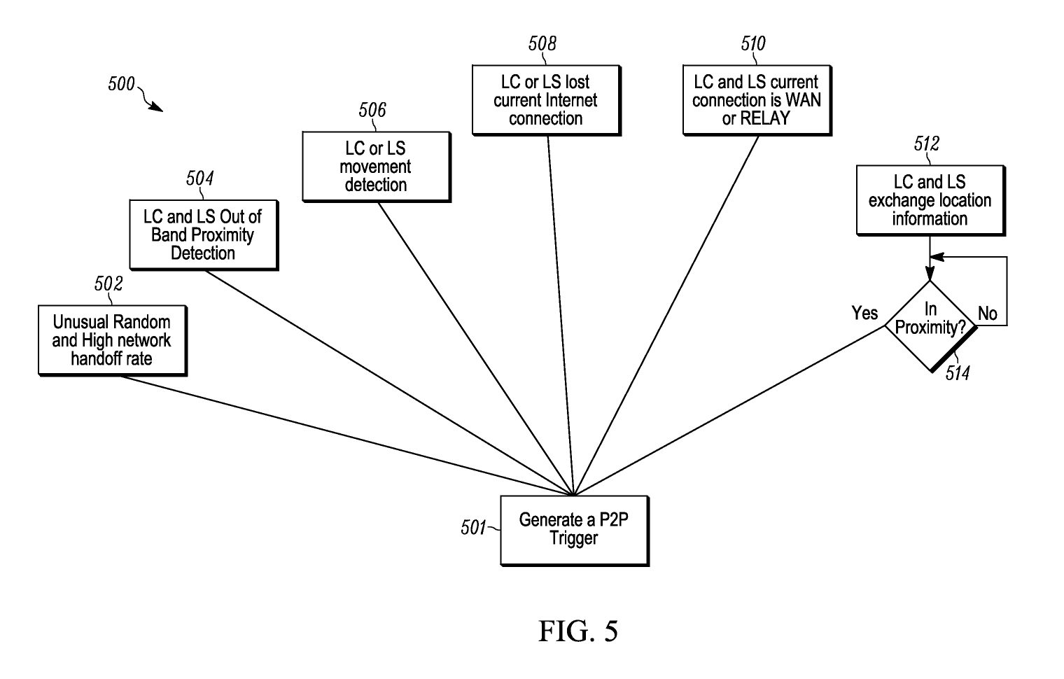

When a triggering event is detected (“Yes” branch from Task 402) (triggers are described in more detail below in connection with FIG. 5), the device determines (task 404) if a current connection exists with a target device (e.g., RELAY, WAN, or LAN). If it is (“Yes” branch from Task 404), the device uses the connection to tell the target device to join a fallback P2P connection.

Each device then scans (Task 410) for a P2P network such as, for example, a Wi-Fi direct, Wi-Fi ad hoc, or Wi-Fi mesh type network. If such a network is found (“Yes” branch from Task 410), the device joins that P2P network (Task 412). If a P2P network is not found (“No” branch from Task 410), the device creates one (Task 420), for example, as described above in connection with FIG. 3.

When a device scans for and finds a P2P network (“Yes” branch from Task 410) and joins that network, it then looks (Task 414) for other devices on the network, typically by searching for some form of device ID associated with the target device. If the target device is found (“Yes” branch from Task 416), the two devices connect and communicate with each other (Task 418) over the P2P network. For example, the two devices can share a data file between them, upon the first device receiving an indication that the target device had connected to the P2P network.

Referring again to Task 420, when the device creates a new P2P network or, alternatively, if the target device is not found on an existing P2P network (“No” branch from Task 416), the device uses Bluetooth Low Energy (BLE) to search for a target device belonging to the whitelist (Task 422). If another device is found on the whitelist, one or more of the following services may be used to ultimately connect with that device: i) User Identity Service; ii) Host Status Service; and iii) Wi-Fi Network Service.

More particularly, the User Identity Service may be used to verify (Task 424) the user logged in on the target device. In the event the target device is asleep, the Host Status Service may be used to wake up the device (Task 426). Once the device is awakened (or if it was not asleep), the Wi-Fi Network Service may be used to invite (Task 428) the target device to join the P2P network, whereupon the devices connect and communicate (Task 418) with each other over the fallback P2P network. For example, the two devices can share a data file between them, upon the first device receiving an indication that the target device had connected to the fallback P2P network.

Turning now to FIG. 5, a block diagram 500 illustrates a number of events which can initiate a trigger 501, causing the system to establish a fallback connection to P2P network, as described above in connection with the “Yes” branch from Task 402. More particularly, possible triggers include:
Block 502: Unusual random or high network handoff rate. This trigger may be initiated when the client detects that the device network changes at a high rate, for example, frequently handing off from one Wi-Fi network to another or from Wi-Fi to a 3G or 4G network;
Block 504: Local client and local server out of band proximity detection. This trigger may be initiated when peer devices use out of band methods such as Bluetooth Low Energy (BLE), Near Field Communication (NFC), or other out of band physical methods;
Block 506: Local client or local server movement detection. This trigger may be initiated when either the local client or the local server detects movement of the device outside the boundary of a predetermined geographical region, for example, using a global positioning system (GPS) or an assisted global positioning system (AGPS) protocol;
Block 508: Local client or local server lost Internet connection. This trigger may be initiated when either the local client or local server loses its current connection to the internet;
Block 510: Local client or local server is WAN or RELAY. This trigger may be initiated when the current connection between the local client and the local server employs a RELAY or WAN protocol;
Block 512: Local client and local server exchange location information. In an environment in which the local client and local server periodically exchange their current location information and calculate the distance between the two devices (Task 514), a trigger may be initiated when the devices come within a predetermined distance from each other (“Yes” branch from Task 514).

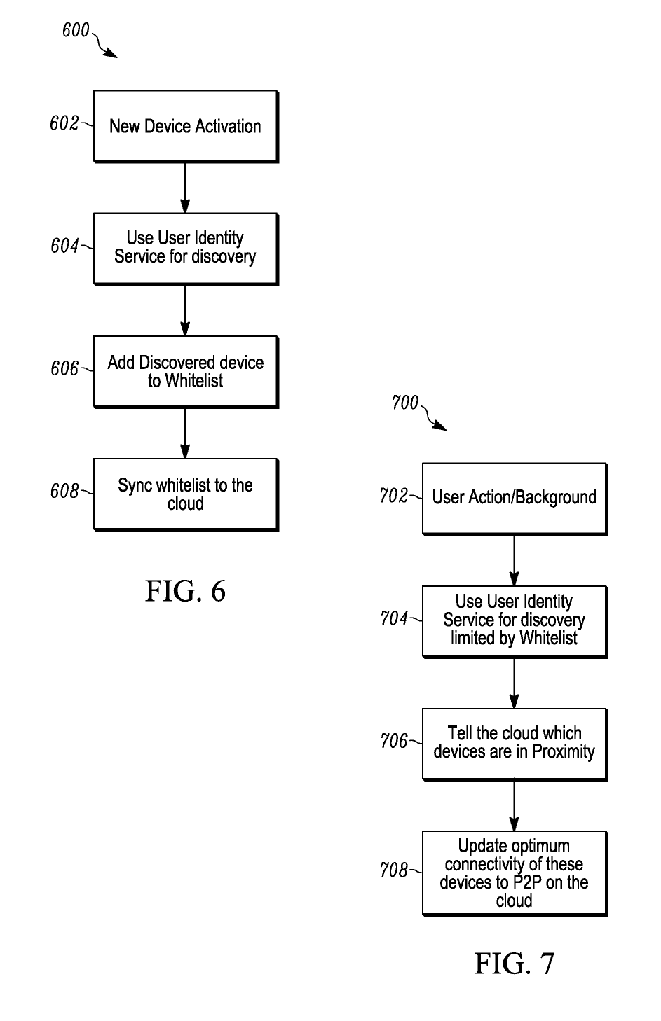

Referring now to FIGS. 6-8, various embodiments, employed by a device, utilize a Bluetooth Low Energy (BLE) or similar feature or protocol to perform various functions, such as: i) to discover target devices belonging to or associated with the same user or user account; ii) to wake up the target device if it is in “sleep” mode; and iii) to exchange P2P network credentials with the nearby target device. In accordance with a preferred embodiment, these features may be facilitated by the Bluetooth 4.0 specification which includes the Bluetooth Low Energy (BLE) protocol, the Bluetooth Attribute (ATT) protocol, and the BLE Generic Attribute (GATT) protocol.

In this regard, the relatively high connection speeds available through Wi-Fi Direct and Wi-Fi IBSS can only be achieved if the devices are closely proximate to maintain the P2P network connection. However, it is an inefficient use of network resources to keep a high speed radio/link “on” all the time and, therefore, devices (or their P2P network connectivity) are often configured to go to sleep when either the device or its P2P connectivity is not in use. Accordingly, in some embodiments of the present disclosure, devices may be configured to “poll” or search the geographic region surrounding a local device to determine when a target device is sufficiently close to permit high speed local connectivity to be turned on, when needed.

More particularly, FIG. 6 illustrates a method 600 for associating a plurality of devices with the same user account during initial device registration. Method 600 includes registering and activating (Task 602) a new device on the cloud. Using the User Identity Service or similar functionality, the device is used to discover (Task 604) additional devices belonging to the user. Any discovered devices may be added (Task 606) to the BLE Device list (or Whitelist), for example, as also provided for in the Bluetooth 4.0 specification. Method 600 then synchronizes the whitelist to the cloud (Task 608), thereby updating the user account information on the cloud with the identity of additional devices associated with the user's account.

FIG. 7 illustrates a method 700 for discovering any other devices belonging to the same user account which are in close proximity to the local device being operated by the user. More particularly, method 700 typically involves the situation where the user is operating (Task 702) the local device with an active P2P connection, and desires to locate nearby devices belonging to the same user account. Method 700, as performed by the local device, searches (Task 704) for target devices contained in the Whitelist by employing, for example, the User Identity Service function. The method then informs (Task 706) the cloud as to which devices are in proximity, and updates (Task 708) the optimum connectivity which is available for these devices in the cloud.

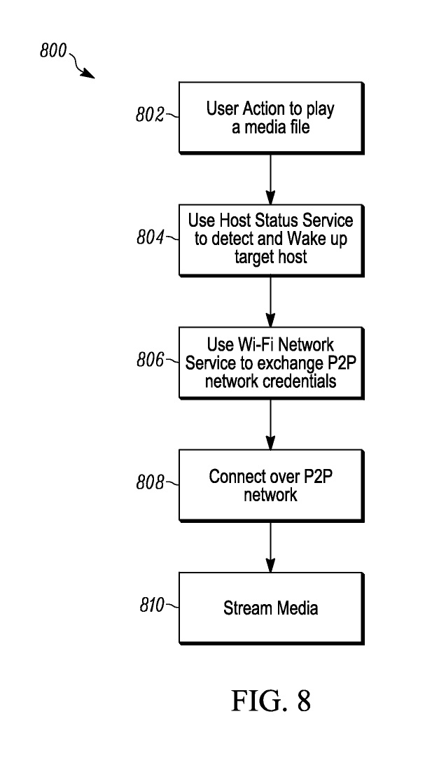

FIG. 8 illustrates a method 800 for waking up local proximity devices belonging to the same account that are sleeping, and either exchanging network credentials with the devices, and/or storing this information in the cloud.

More particularly, method 800, as performed by a local device, involves a request (Task 802) by a user to access a media file located on a target device. Using, for example, the Host Status Service, the target device upon which the media file is located is detected and awakened (Task 804). The local user device exchanges (Task 806) P2P network credentials with the target device, and connects (Task 808) with the target device using the P2P credentials. Once connected, the local device may stream media (Task 810) from the target device, or alternatively stream media to the target device, or stream media between the local and target devices.

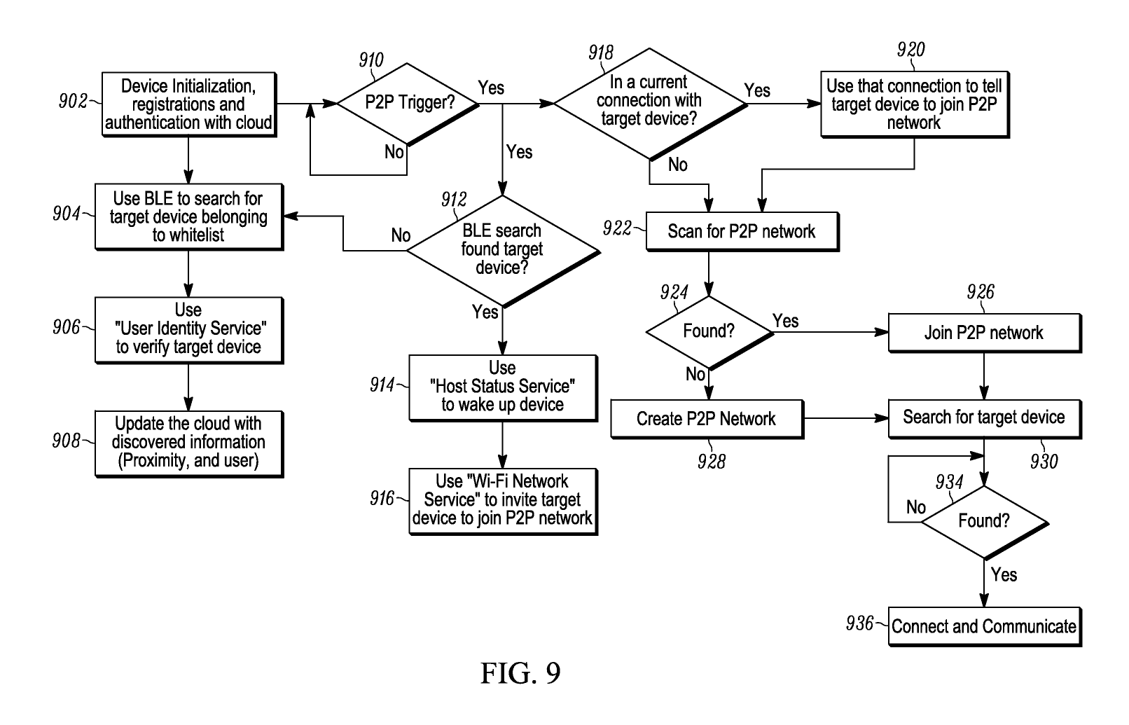

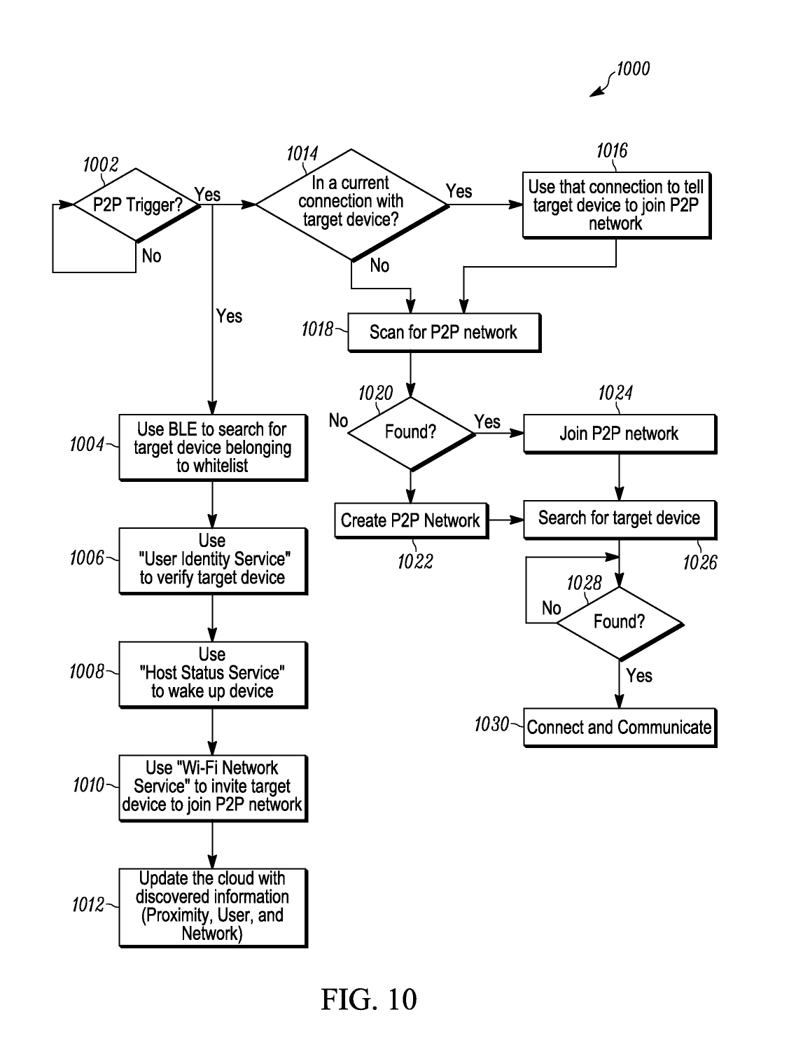

FIGS. 9 and 10 illustrate alternative embodiments of methods of implementing a fallback peer-to-peer (P2P) network for sharing media among devices.

Referring to FIG. 9, a flow diagram 900 illustrates an alternate policy for a connecting to a fallback P2P network, wherein the BLE searching discussed above may be performed prior to a triggering event. BLE searching may also be done in parallel with P2P scanning and connections. In the policy illustrated in FIG. 9, the waking up of a sleeping device is performed after a triggering event is detected.

Method 900, as performed by a device, for example, involves initializing, registering, and authenticating a device with the web-based central server, or cloud (Task 902). BLE searching is performed to look for target devices belonging to the whitelist (Task 904). In this regard, the term BLE searching refers to searching using BLE.

Method 900 further includes using a User Identity Service to verify a target device (Task 906), and updating the whitelist maintained by the cloud with information pertaining to devices associated with a particular user account which are determined to be closely proximate to the device that conducted the searching (Task 908).

The local device continues to poll for a trigger (“No” branch from Task 910). When a triggering event is detected (“Yes” branch from Task 910), the device uses the results from the BLE searching to find the target device (Task 912). If a target device is not found (“No” branch from Task 912), the device uses BLE searching to look for target devices belonging to the whitelist (Task 904). If a target device is found (“Yes” branch from Task 912), Host Status Service is used to wake up (Task 914) the target device if it is asleep; if the target device is not asleep it is invited (Task 916) to join the P2P network using Wi-Fi Network Service.

Returning to Task 910, if a triggering event is detected (“Yes” branch from Task 910) the local device determines (Task 918) if it is in a current connection with the target device. If so (“Yes” branch from Task 918), the local device uses that connection to tell the target device to join the P2P network (Task 920). If no current connection exists (“No” branch from Task 918), the local device scans for a P2P network (Task 922). If a P2P network is found (“Yes” branch from Task 924), the local device joins the P2P network (Task 926), and searches for a target device (Task 930). If a P2P network is not found (“No” branch from Task 924), the local device creates a P2P network (Task 928) and searches for a target device (Task 930).

The method 900 includes the local device continuing to search for a target device (“No” branch from Task 934). When a target device is found (“Yes” branch from Task 934), the target device connects to the P2P network (Task 936) and the local device communicates with the target device via the P2P network. For example, the two devices can share a data file between them, upon the first device receiving an indication that the target device had connected to the P2P network.

Referring to FIG. 10, a flow diagram 1000 illustrates an alternate policy for a connecting to a fallback P2P network, wherein the BLE searching may be performed in parallel with Wi-Fi searching in response to a triggering event. The local device continues to poll for a trigger (“No” branch from Task 1002). When a triggering event is detected (“Yes” branch from Task 1002), the device uses BLE searching to search for a target device belonging to the whitelist (Task 1004).

In an embodiment, the local device uses a User Identity Service to verify (Task 1006) the target device. If the target device is asleep, Host Status Service is used to wake it up (Task 1008). A Wi-Fi Network Service may be used to invite the target device to join a P2P network (Task 1010), whereupon the cloud is updated (Task 1012) with the discovered information (e.g., which devices are closely proximate the local device, which devices are associated with a particular user account, and the identities of available networks).

Also upon the detection of a triggering event (“Yes” branch from Task 1002), the local device determines if a current connection exists with the target device (Task 1014) and, if so, that connection is used to tell the target device to join the P2P network (Task 1016). If no current connection exists (“No” branch from Task 1014), the local device scans for P2P networks (Task 1018. If no P2P network is found (“No” branch from Task 1020), the local device creates a P2P network (Task 1022). If an existing P2P network is found (“Yes” branch from Task 1020), the local device joins the P2P network (Task 1024) and searches for a target device (Task 1026).

The local device continues searching for a target device (“No” branch from Task 1028). When a target device is found (“Yes” branch from Task 1028), the target device connects to the P2P network and communicates with the local device (Task 1030). For example, the two devices can share a data file between them, upon the first device receiving an indication that the target device had connected to the P2P network.

It is understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts described herein.

As understood by those in the art, controller 204 includes a processor that executes computer program code to implement the methods described herein. Embodiments include computer program code containing instructions embodied in tangible media, such as floppy diskettes, CD-ROMs, hard drives, or any other computer-readable storage medium, wherein, when the computer program code is loaded into and executed by a processor, the processor becomes an apparatus for implementing the methods and apparatus described herein.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

It will be appreciated that the above description for clarity has described various embodiments with reference to different functional units and processors. However, it will be apparent that any suitable distribution of functionality between different functional units or processors may be used. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

While at least one embodiment has been presented in the foregoing detailed description, it should be appreciated that a vast number of variations exist. It should also be appreciated that the various embodiments are only examples, and are not intended to limit the scope, applicability, or configuration of the devices and methods described herein. Rather, the foregoing detailed description will provide those skilled in the art with a convenient road map for implementing these embodiments. It being understood that various changes may be made in the function and arrangement of elements described herein without departing from the scope of the disclosure as set forth in the appended claims.

What is claimed is:

1. A method of sharing data files among devices, comprising:
scanning for a fallback peer-to-peer (P2P) network by a first device;
joining said fallback P2P network when said scanning finds said fallback P2P network;
creating said fallback P2P network when said scanning does not find said fallback P2P network;
searching for a second device, with the first device, using a Bluetooth generic attribute (GATT) personal device profile (PDP) protocol;
and
sharing a data file between said first and second devices upon receiving an indication that said second device had connected to said fallback P2P network.

2. The method of claim 1, wherein searching comprises searching using at least one of the following protocols: Bluetooth Low Energy (BLE); Bluetooth basic rate (BR); and Bluetooth enhanced data rate (EDR).

3. The method of claim 1, wherein said first and second devices are associated with a single user account.

4. The method of claim 1, wherein first and second devices are cloud-based devices.

5. The method of claim 1, further comprising the first device verifying whether said second device is connected to said fallback P2P network.

6. The method of claim 5, wherein verifying comprises verifying user logged on information in said cloud using a User Identity Service using at least one of Bluetooth Low Energy (BLE), Bluetooth basic rate (BR), and Bluetooth enhanced data rate (EDR).

7. The method of claim 1, wherein searching for a second device with the first device comprises determining whether said second device is on a BLE whitelist residing on said first device.

8. The method of claim 7, further comprising adding said second device to said whitelist if said second device is not on said whitelist.

9. The method of claim 7, further comprising synchronizing said BLE whitelist stored on said first device with a web-based white list stored on a central server cloud computer.

10. The method of claim 1, wherein verifying comprises determining whether said second device is in a sleep mode.

11. The method of claim 5, further comprising:
when said second device is not asleep, connecting said first and second devices via said fallback P2P network; and
when said second device is asleep, waking up said second device using a Host Status Service prior to connecting said first and second devices via said fallback P2P network.

12. The method of claim 5, wherein verifying comprises determining whether said second device is asleep using a Host Status Service.

13. The method of claim 1, further comprising communicating, by said first device to said second device, network credentials of said fallback P2P network.

14. The method of claim 13, wherein communicating comprises communicating network credentials using a Wi-Fi Network Service.

15. The method of claim 14, wherein said P2P network credentials include at least one of:
a network name;
a network SSID;
a network type;
a network password; and
a network security protocol.

16. The method of claim 1, wherein said fallback P2P network is compliant with at least one of Bluetooth, BLE, Wi-Fi, and IEEE 802.11.

17. The method of claim 1, wherein sharing comprises sharing a media file.

18. The method of claim 1, wherein sharing comprises streaming media between the first device and the second device.

19. The method of claim 18, wherein said media file comprises at least one of a text, graphics, and video format.

20. The method of claim 1, wherein scanning comprises scanning in response to a triggering event, said triggering event comprising at least one of:
network handoff rate exceeding a predetermined threshold value;
out of band proximity detection;
movement of one of said first and second devices into a predetermined geographic region;
termination of an Internet connection of at least one of said first and second devices; and
the distance between said first and said second devices becomes less than a predetermined value.

21. The method of claim 1, further comprising:
prior to connecting said second device to said fallback P2P network, accessing media located on said second device from said first device via a web-based central server; and
after connecting said second device to said fallback P2P network, continuing to access media located on said second device via said fallback P2P network.

22. A method of sharing media files among associated electronic devices using a fallback peer-to-peer (P2P) network, the method comprising:
scanning for a fallback P2P network by a first device;
when said fallback P2P network is found, joining said P2P network and searching for a second device;
when said second device is found, connecting said first device to said second device via said fallback P2P network;
when said second device is not found, searching for a second device, with the first device, using a Bluetooth generic attribute (GATT) personal device profile (PDP) protocol; and
connecting said first device to said second device, where said second device is connected to said fallback P2P network.

23. The method of claim 22, wherein scanning comprises scanning in response to a triggering event, said triggering event comprising at least one of:
network handoff rate exceeding a predetermined threshold value;
out of band proximity detection;
movement of one of said first and second devices into a predetermined geographic region;
termination of an Internet connection of at least one of said first and second devices; and
the distance between said first and said second devices becomes less than a predetermined value.

24. The method of claim 22, wherein sharing comprises streaming media between said first and said second devices.

25. The method of claim 22, further comprising:
prior to connecting said first and second devices via said fallback P2P network, accessing media located on said second device from said first device via a web-based central server; and
after connecting said first and second devices via said fallback P2P network, continuing to access media located on said second device via said fallback P2P network.

26. The method of claim 25, wherein continuing comprises streaming media between said first and said second devices.

27. An apparatus for streaming media stored on a closely proximate device, comprising:
a memory module configured to store a device-based whitelist of associated devices including said closely proximate device;
an Internet connection module configured to connect to a web-based central server and to synchronize said device-based whitelist with a cloud-based whitelist maintained on said central server; and
a searching module configured to search for said closely proximate device using a Bluetooth generic attribute (GATT) personal device profile (PDP) protocol; and
a P2P network connection module configured to connect to said closely proximate device through a fallback P2P network when said closely proximate device is found by said searching module.

28. A method for managing electronic devices belonging to the same user account, comprising:
storing a first whitelist on a first device;
storing a second whitelist on a web-based central server;
searching, by said first device, for target devices in close proximity to said first device;
connecting said first device to said central server; and
synchronizing said first and second whitelists.

29. The method of claim 28, wherein searching comprises searching using a User Identity Service.

30. The method of claim 28, further comprising connecting said first device to a P2P network prior to searching.

31. The method of claim 28, further comprising:
storing a third whitelist on a third device; and
synchronizing said first, second, and third whitelists when said searching discovers said third device.

32. The method of claim 28, wherein said first and second whitelists include: i) information relating to the identity of devices stored on said whitelists; and ii) information relating to P2P network connectivity for devices stored on said whitelists.
